(19) United States
(12) Patent Application Publication
(10) Pub. No.: US 2015/0255809 A1
(43) Pub. Date: Sep. 10, 2015

(54) FUEL CELL SYSTEM HAVING HEAT EXCHANGER

(71) Applicant: Samsung SDI Co., Ltd., Yongin-si (KR)

(72) Inventors: Jong-Rock CHOI, Yongin-si (KR); Dong-Rak KIM, Yongin-si (KR); Jeong-Kurn PARK, Yongin-si (KR); In-Seob SONG, Yongin-si (KR)

(73) Assignee: Samsung SDI Co., Ltd., Yongin-si (KR)

(21) Appl. No.: 14/289,906

(22) Filed: May 29, 2014

(30) Foreign Application Priority Data
Mar. 7, 2014 (KR) 10-2014-0027037

(51) Int. Cl. H01M 8/04

(52) U.S. Cl. CPC H01M 8/04014; H01M 8/04029

(57) ABSTRACT

A fuel cell system having a heat exchanger capable of separating gas and liquid is disclosed. In one aspect, the fuel cell system includes a fuel cell stack and an inlet header connected to the fuel cell stack, wherein the inlet header comprises first and second surfaces opposing each other. The fuel cell system also includes a cathode heat exchanger connected to the first surface of the inlet header and an anode heat exchanger connected to the second surface of the inlet header. The cathode heat exchanger is configured to exhaust a gas and the anode heat exchanger is configured to store and discharge a liquid.

### INCORPORATION BY REFERENCE TO ANY PRIORITY APPLICATIONS

This application claims priority to and the benefit of Korean Patent Application No. 10-2014-0027037, filed on Mar. 7, 2014, in the Korean Intellectual Property Office, the entire contents of which are incorporated herein by reference in their entirety.

### BACKGROUND

1. Field

The described technology generally relates to fuel cell system having a heat exchanger.

2. Description of the Related Technology

Direct liquid fuel cells are power generation devices which generate electricity through an electrochemical reaction between an organic compound fuel, such as methanol or ethanol, and oxygen which is an oxidizer. Direct liquid fuel cells have a very high energy density and power density and can directly use liquid fuels such as methanol. Accordingly, direct liquid fuel cells do not require a peripheral device such as a fuel reformer and can easily store and supply fuel.

The standard direct liquid fuel cell has an electrolytic membrane interposed between anode and cathode electrodes. Each of the anode and cathode electrodes has a fuel diffusion layer for the supply and diffusion of fuel, a catalyst layer in which oxidation/reduction reactions of fuel occur, and an electrode supporter. A precious metal catalyst, such as platinum, having desirable properties even at low temperatures is used as the catalyst for electrode reaction. An alloy catalyst of a transition metal such as ruthenium, rhodium, osmium or nickel is used to prevent catalyst poisoning caused by carbon monoxide which is a reaction by-product. Carbon paper, carbon fabric or the like is used as the electrode supporter and the electrode supporter is water-proofed to facilitate the supply of fuel and the discharge of the reaction by-product. The electrolytic membrane is a hydrogen ion exchange membrane which contains moisture as a polymer membrane and has ion conductivity.

The electrode reaction of a direct methanol fuel cell (DMFC) using methanol and water as mixture fuel includes an anode reaction in which fuel is oxidized and a cathode reaction in which hydrogen and oxygen are reduced. In addition, water and carbon dioxide are produced by the anode and cathode reactions.

### SUMMARY OF CERTAIN INVENTIVE ASPECTS

One inventive aspect is a fuel cell system having a heat exchanger that can separate gas and liquid and having a simplified configuration.

Another aspect is a fuel cell system having a heat exchanger capable of separating gas and liquid, the heat exchanger including an inlet header receiving non-reactive liquid fuel and gas discharged from anode and cathode electrodes and cathode and anode heat exchangers are respectively arranged on the top and bottom of the inlet header, wherein the cathode and anode heat exchangers and the inlet header are integrally formed.

Another aspect is a fuel cell system having a heat exchanger capable of separating gas and liquid, the fuel cell system including: a fuel cell stack; an inlet header connected to the fuel cell stack; a cathode heat exchanger positioned on the top of the inlet header; and an anode heat exchanger positioned on the bottom of the inlet header, wherein the cathode heat exchanger exhausts a gas and the anode heat exchanger stores and discharges a liquid.

The cathode heat exchanger may cool and exhaust the gas.

The anode heat exchanger may store the liquid condensed in the cathode heat exchanger.

The inlet header may be connected to the fuel cell stack by an inflow pipe such that a fluid discharged from the fuel cell stack is received by the inlet header.

The inflow pipe may include a first inflow pipe through which a first fluid generated by an anode reaction is received in the inlet header from the fuel cell stack and a second inflow pipe through which a second fluid generated by a cathode reaction is received in the inlet header from the fuel cell stack.

The inlet header may be provided with at least one first inflow port to which one end of the first inflow pipe is connected and at least one second inflow port to which one end of the second inflow pipe is connected.

A gas exhaust port may be formed at the upper end of the cathode heat exchanger.

A liquid discharge port may be formed at the lower end of the anode heat exchanger.

A liquid level measuring unit for measuring the amount of liquid stored in the anode heat exchanger may be further formed on an outer surface of the anode heat exchanger.

The liquid level measuring unit may control the discharge of the liquid through the liquid discharge port when a predetermined amount of the liquid is stored in the anode heat exchanger.

Each of the cathode and anode heat exchangers may include two header pipes, a plurality of tubes arranged perpendicular to the header pipes to allow the header pipes to fluidly communicate with each other, and wrinkled heat dissipation fins respectively interposed between the tubes.

The heat dissipation fin may be formed of copper.

Another aspect is a fuel cell system comprising a fuel cell stack; an inlet header connected to the fuel cell stack, wherein the inlet header comprises first and second surfaces opposing each other; a cathode heat exchanger connected to the first surface of the inlet header; and an anode heat exchanger connected to the second surface of the inlet header, wherein the cathode heat exchanger is configured to exhaust a gas and wherein the anode heat exchanger is configured to store and discharge a liquid.

The cathode heat exchanger can be further configured to cool the gas and exhaust the cooled gas. The cathode heat exchanger can be further configured to condense at least a portion of a fluid into the liquid and the anode heat exchanger can be further configured to store the condensed liquid. The inlet header can be connected to the fuel cell stack via an inflow pipe configured to receive a fluid discharged from the fuel cell stack. The inflow pipe can include a first inflow pipe configured to receive a first fluid generated by an anode reaction from the fuel cell stack and a second inflow pipe configured to receive a second fluid generated by a cathode reaction from the fuel cell stack. The inlet header can comprise a first inflow port connected to the first inflow pipe and a second inflow port connected to the second inflow pipe. The cathode heat exchanger can comprise a gas exhaust port formed at an upper end thereof. The anode heat exchanger can comprise a liquid discharge port formed at a lower end thereof. The fuel cell system can further comprise a liquid level measuring unit configured to measure the amount of liquid stored in the anode heat exchanger, wherein the liquid level measuring unit is formed on an outer surface of the anode heat exchanger. The liquid level measuring unit can be configured to control the discharge of the liquid through the liquid discharge port when the amount of liquid stored in the anode heat exchanger is greater than a threshold. Each of the cathode and anode heat exchangers can include two header pipes, a plurality of tubes arranged substantially perpendicular to and between the header pipes and configured to provide fluid communication between the header pipes, and a plurality of wrinkled heat dissipation fins respectively interposed between the tubes. The heat dissipation fins can be formed of copper. The cathode heat exchanger can comprise a gas storage tank formed at an upper portion thereof and configured to store the gas and the cathode heat exchanger can comprise a liquid storage tank formed at a lower portion thereof and configured to store the liquid.

Another aspect is a fuel cell system, comprising a fuel cell stack configured to discharge a fluid; and a heat exchanger configured to separate the fluid into a gas and a liquid, wherein the heat exchanger includes: an inlet header configured to receive the fluid from the fuel cell stack, wherein the inlet header comprises first and second surfaces opposing each other; a cathode heat exchanger connected to the first surface of the inlet header; and an anode heat exchanger connected to the second surface of the inlet header and configured to store the liquid.

The anode heat exchanger can be further configured to supply the liquid back to the fuel cell stack. The cathode heat exchanger can be configured to condense at least a portion of the fluid into the liquid and the anode heat exchanger can be further configured to store the condensed liquid. The fluid can includes first and second fluids respectively generated by anode and cathode reactions, the fuel cell system can further comprise a first inflow pipe configured to receive the first fluid from the fuel cell stack; and a second inflow pipe configured to receive the second fluid from the fuel cell stack, wherein the inlet header is connected to the fuel cell stack via the first and second inflow pipes. The heat exchanger can further comprise a liquid level measuring unit configured to measure the amount of liquid stored in the anode heat exchanger and the liquid level measuring unit can be formed on an outer surface of the anode heat exchanger. The liquid level measuring portion can be configured to control the discharge of the liquid through a liquid discharge port when the amount of liquid stored in the anode heat exchanger is greater than a threshold. Each of the cathode and anode heat exchangers can include two header pipes, a plurality of tubes arranged substantially perpendicular to and between the header pipes and configured to provide fluid communication between the header pipes, and a plurality of wrinkled heat dissipation fins respectively interposed between the tubes.

According to at least one embodiment, fuel cell system components are integrated so that components such as a pump and a gas-liquid separator can be omitted, thereby simplifying the fuel cell system. In addition, it is possible to reduce manufacturing cost and to facilitate the maintenance and repair of the fuel cell system.

Further, a heat dissipation body, such as a high-temperature water storage unit, is not required in the fuel cell system improving the heat design and arrangement of components within the system.

### BRIEF DESCRIPTION OF THE DRAWINGS

FIG. 1 is a schematic view showing a fuel cell system having a heat exchanger that can separate gas and liquid according to an embodiment.

FIG. 2 is a schematic view showing the heat exchanger of FIG. 1.

FIG. 3 is a perspective view showing a heat exchanger according to an embodiment.

FIG. 4 is a perspective view showing the flow of gas and liquid through the heat exchanger of FIG. 3.

FIG. 5 is a view showing the inside of the heat exchanger according to an embodiment.

### DETAILED DESCRIPTION OF CERTAIN INVENTIVE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, the dimensions of components may be exaggerated for clarity of illustration. It will be understood that when an element is referred to as being “between” two elements, it can be the only element between the two elements, or one or more intervening elements may also be present Like reference numerals refer to like elements throughout.

In the following detailed description, only certain exemplary embodiments have been shown and described, simply by way of illustration. As those skilled in the art would realize, the described embodiments may be modified in various different ways, all without departing from the spirit or scope of the described technology. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thicknesses or sizes of layers or components may be exaggerated for the sake of clarity and are not necessarily drawn to scale. The term “substantially” as used in this disclosure can include the meanings of completely, almost completely, or to any significant degree in some applications and in accordance with the understanding of those skilled in the art.

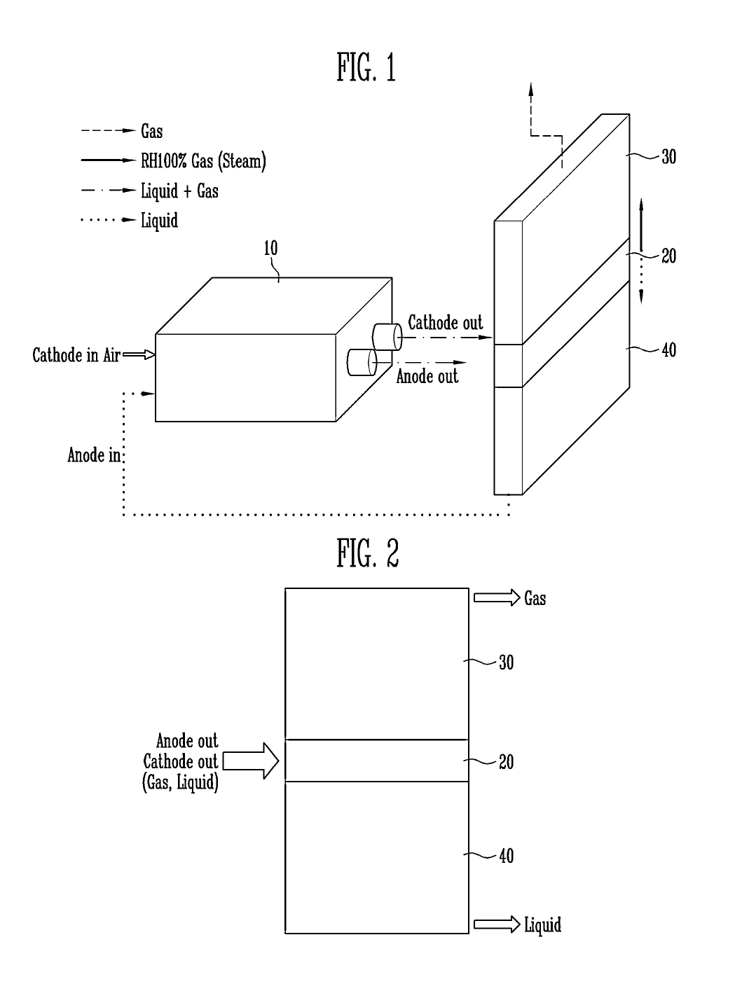

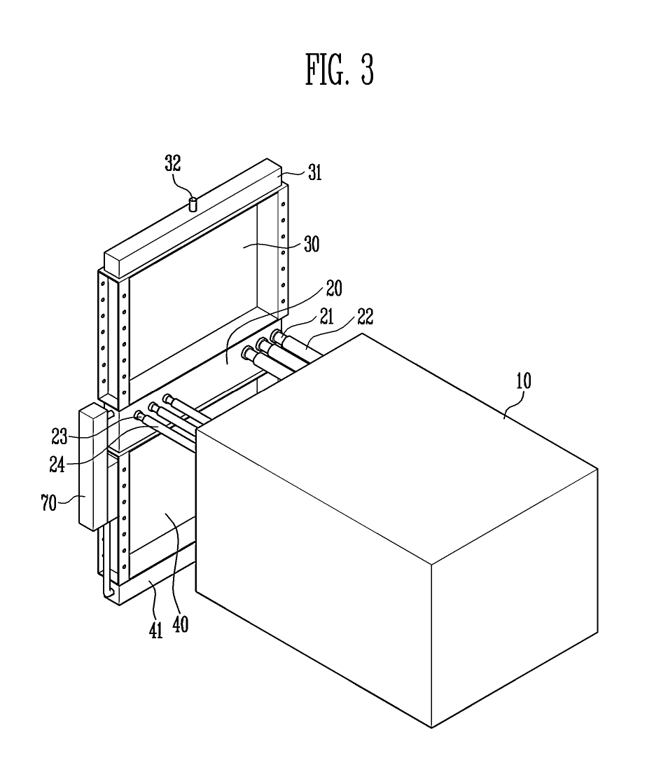

FIG. 1 is a schematic view showing a fuel cell system having a heat exchanger that can separate gas and liquid according to an embodiment. FIG. 2 is a schematic view showing the heat exchanger of FIG. 1.

Referring to FIGS. 1 and 2, the fuel cell system having the heat exchanger capable of separating gas and liquid includes a fuel cell stack 10, an inlet header 20, a cathode heat exchanger 30 and an anode heat exchanger 40. The inlet header 20 has one region connected to the fuel cell stack 10. The cathode heat exchanger 30 and the anode heat exchanger 40 are respectively positioned on the top and bottom of the inlet header 20. That is, as shown in FIG. 2, the inlet header 20, the cathode heat exchanger 30 and the anode heat exchanger 40 can be integrally formed to form the heat exchanger capable of separating gas and liquid.

Accordingly, fluid discharged from the fuel cell stack 10 flows into the inlet header 20 which is positioned between the cathode and anode heat exchangers 30 and 40. After flowing into the inlet header 20, the fluid flows to the upper and lower ends of the inlet header 20. A gas portion of the fluid flows to the cathode heat exchanger 30, positioned over the inlet header 20, and is cooled, thus exhausting the cooled gas. A liquid condensed in the cathode heat exchanger 30 flows to the anode heat exchanger 40 at the bottom of the inlet header 20, where it is stored and then discharged at a predetermined temperature.

The liquid condensed in the cathode heat exchanger 30 over of the inlet header 20 falls into the anode heat exchanger 40 at the bottom of the inlet header 20. In some embodiments, the anode heat exchanger 40 formed on the bottom of the inlet header 20 not only functions as a heat exchanger but also simultaneously functions as a liquid reservoir.

FIG. 1 illustrates the flow of fluids through the fuel cell system according to an embodiment. The fuel cell stack 10 includes cathode and anode input ports which receive different fluids. Similarly, the fuel cell stack 10 includes cathode and anode output ports which discharge the fluids to the inlet header 20. In some embodiments, air is received at the cathode input port and liquid is received at the anode input port. A fluid mixture of liquid and gas is output from each of the cathode and anode output ports. The liquid and gas of the output fluids are separated in the heat exchanger and the liquid from the anode heat exchanger 40 can be fed back into the anode input port. The state of the fluids flowing through the fuel cell system (e.g. gas, liquid, or gas and liquid) is indicated by the different lines in the figure. The solid line represents a relative humidity of 100%, e.g. steam.

The standard fuel cell system includes a fuel cell stack, a gas-liquid separator that acts as a liquid reservoir and is connected to the fuel cell stack, a cathode heat exchanger and an anode heat exchanger. Therefore, the standard fuel cell system has a complicated structure. Further, in the standard fuel cell system, the components are arranged so that the length of the path of the gas exhausted from the fuel cell stack is minimized.

When high-temperature components and medium-/low-temperature components are arranged in the same area, medium-/low-temperature components, such as a pump, are exposed to a higher temperature than is necessary. This heating of the medium-/low-temperature components negatively affects the durability of the fuel cell system. When using a liquid pump, the pump must be positioned remotely to prevent overheating and consequently the length of pipes in the system must be lengthened, however, power consumption is not greatly affected when transfer pressure increases. However, when using a gas pump, e.g. a fan motor such as a blower, the power consumption of the fan motor is sensitive to changes in pressure, resulting in an increase in power usage when fan motor is positioned remotely.

Thus, according to at least one embodiment, the inside of the anode heat exchanger 40 is completely filled with the liquid, and thus, the anode heat exchanger 40 can function as a liquid reservoir. Accordingly, gas-liquid separation is possible in the anode heat exchanger 40 and an additional liquid reservoir can be omitted from the fuel cell system.

That is, according to at least one embodiment, components of the fuel cell system which are typically separate can be integrated, simplifying the fuel cell system. In addition, it is possible to reduce manufacturing cost and to facilitate maintenance and repair of the fuel cell system. A heat dissipation body such as a high-temperature liquid reservoir is removed from the fuel cell system, so that heat design and arrangement advantageous of the fuel cell system are possible.

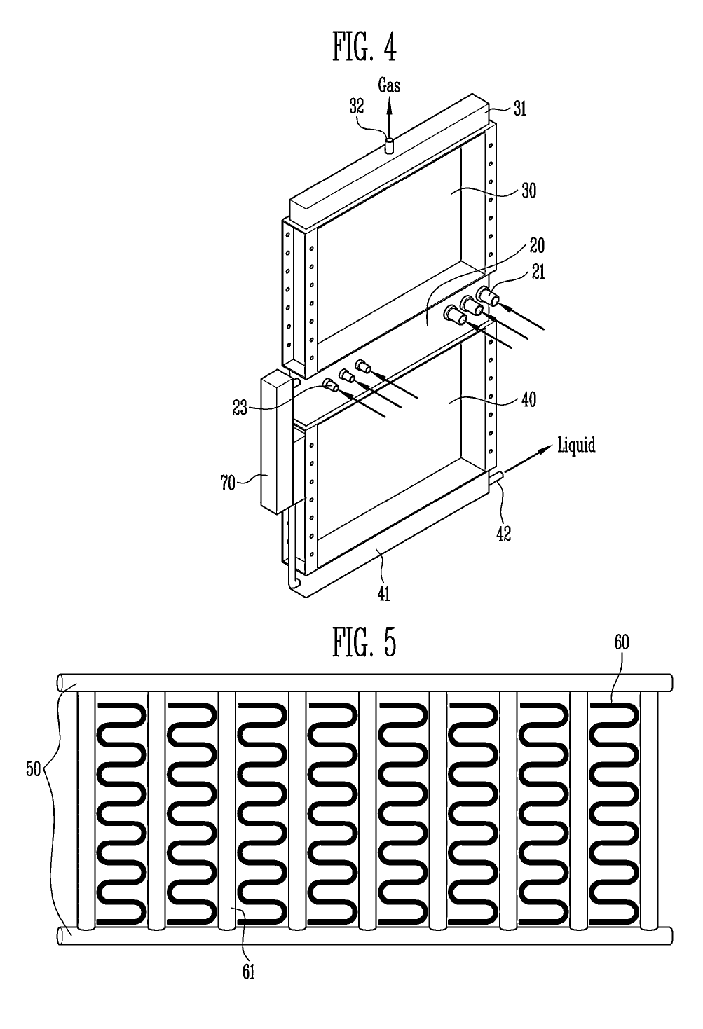

FIG. 3 is a perspective view showing a heat exchanger capable of separating gas and liquid in a fuel cell system according to an embodiment. FIG. 4 is a perspective view showing the flow of gas and liquid in the heat exchanger of FIG. 3.

Referring to FIGS. 3 and 4, the fuel cell system includes a fuel cell stack 10, an inlet header 20 having one region connected to the fuel cell stack 10, and cathode and anode heat exchangers respectively positioned on the top and bottom of the inlet header 20. The inlet header 20, the cathode heat exchanger 30 and the anode heat exchanger 40 may be integrated to form a flow-path that gas or liquid can easily flow therethrough.

The inlet header 20 is connected to the fuel cell stack 10 by inflow pipes 22 and 24. A fluid discharged from the fuel cell stack 10 flows into the inlet header 20 via the inflow pipes 22 and 24. The inflow pipes 22 and 24 include a first inflow pipe 22 through which a first fluid generated by an anode reaction flows into the inlet header 20 from the fuel cell stack 10 and a second inflow pipe 24 through which a second fluid generated by a cathode reaction flows into the inlet header 20 from the fuel cell stack 10.

The inlet header 20 includes at least one first inflow port 21 to which one end of the first inflow pipe 22 is connected and at least one second inflow port 23 to which one end of the second inflow pipe 24 is connected. Accordingly, the fluid discharged from the fuel cell stack 10 flows into the inlet header 20 and the inlet header discharges gas and liquid to the respective cathode and anode heat exchangers 30 and 40.

A gas storage portion or gas storage tank 31 is formed at an upper end of the cathode heat exchanger 30 and a gas exhaust portion or gas exhaust port 32 is formed in the gas storage portion 31. The gas exhaust portion 32 is configured to release gas from the gas storage portion 31. In addition, liquid storage portion or liquid storage tank 41 is formed at a lower end of the anode heat exchanger 40 and a liquid discharge port 42 is formed at one side of the liquid storage portion 41. The liquid discharge port 42 is configured to discharge liquid from the liquid storage portion 42. Based on the described configuration of the fuel cell system, the gas can be exhausted to the cathode heat exchanger 30 and the liquid can be stored and discharged to the anode heat exchanger 40.

In some embodiments, the liquid stored in the anode heat exchanger 40 is discharged when the amount of the liquid is greater than a predetermined amount. In the FIG. 3 embodiment, a liquid level measuring portion or liquid level measurement unit 70 for measuring the amount of liquid stored in the anode heat exchanger 40 is further formed on an outer surface of the anode heat exchanger 40. If a predetermined amount of liquid or greater is stored in the anode heat exchanger 40, the liquid level measuring portion 70 discharges the liquid through the liquid discharge port 42.

FIG. 5 is a view showing the inside of the heat exchanger according to an embodiment.

Referring to FIG. 5, in each of the cathode and anode heat exchangers 30 and 40, a plurality of tubes 61 are arranged perpendicular to and between two header pipes 50. Additionally, wrinkled heat dissipation fins 60 are respectively placed between the tubes 61. The heat dissipation fin 60 may be formed of copper.

That is, in the cathode heat exchanger 30 and the anode heat exchanger 40, the wrinkled heat dissipation fin 60 is arranged in the space between each of the tubes 61, thereby contributing to the heat exchange with the air.

According to some embodiments, the heat exchanger has a structure including the two header pipes 50 opposing each other, the tubes 61 that allow fluid communication between the header pipes 50, and the wrinkled heat dissipation fins 60 respectively interposed between the tubes 61. In the above described heat exchanger, heat is dissipated due to air passing between the heat dissipation fins 60 while a refrigerant is circulated through the tubes 61, thereby performing heat exchange.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with the features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A fuel cell system, comprising:
a fuel cell stack;
an inlet header connected to the fuel cell stack, wherein the inlet header comprises first and second surfaces opposing each other;
a cathode heat exchanger connected to the first surface of the inlet header; and
an anode heat exchanger connected to the second surface of the inlet header,
wherein the cathode heat exchanger is configured to exhaust a gas and wherein the anode heat exchanger is configured to store and discharge a liquid.

2. The fuel cell system of claim 1, wherein the cathode heat exchanger is further configured to cool the gas and exhaust the cooled gas.

3. The fuel cell system of claim 1, wherein the cathode heat exchanger is further configured to condense at least a portion of a fluid into the liquid and wherein the anode heat exchanger is further configured to store the condensed liquid.

4. The fuel cell system of claim 1, wherein the inlet header is connected to the fuel cell stack via an inflow pipe configured to receive a fluid discharged from the fuel cell stack.

5. The fuel cell system of claim 4, wherein the inflow pipe includes i) a first inflow pipe configured to receive a first fluid generated by an anode reaction from the fuel cell stack and ii) a second inflow pipe configured to receive a second fluid generated by a cathode reaction from the fuel cell stack.

6. The fuel cell system of claim 5, wherein the inlet header comprises i) a first inflow port connected to the first inflow pipe and ii) a second inflow port connected to the second inflow pipe.

7. The fuel cell system of claim 1, wherein the cathode heat exchanger comprises a gas exhaust port formed at an upper end thereof.

8. The fuel cell system of claim 1, wherein the anode heat exchanger comprises a liquid discharge port formed at a lower end thereof.

9. The fuel cell system of claim 8, further comprising a liquid level measuring unit configured to measure the amount of liquid stored in the anode heat exchanger, wherein the liquid level measuring unit is formed on an outer surface of the anode heat exchanger.

10. The fuel cell system of claim 9, wherein the liquid level measuring unit is configured to control the discharge of the liquid through the liquid discharge port when the amount of liquid stored in the anode heat exchanger is greater than a threshold.

11. The fuel cell system of claim 1, wherein each of the cathode and anode heat exchangers includes i) two header pipes, ii) a plurality of tubes arranged substantially perpendicular to and between the header pipes and configured to provide fluid communication between the header pipes, and iii) a plurality of wrinkled heat dissipation fins respectively interposed between the tubes.

12. The fuel cell system of claim 11, wherein the heat dissipation fins are formed of copper.

13. The fuel cell system of claim 1, wherein the cathode heat exchanger comprises a gas storage tank formed at an upper portion thereof and configured to store the gas and wherein the cathode heat exchanger comprises a liquid storage tank formed at a lower portion thereof and configured to store the liquid.

14. A fuel cell system, comprising:
a fuel cell stack configured to discharge a fluid; and
a heat exchanger configured to separate the fluid into a gas and a liquid, wherein the heat exchanger includes:
an inlet header configured to receive the fluid from the fuel cell stack, wherein the inlet header comprises first and second surfaces opposing each other;
a cathode heat exchanger connected to the first surface of the inlet header; and
an anode heat exchanger connected to the second surface of the inlet header and configured to store the liquid.

15. The fuel cell system of claim 14, wherein the anode heat exchanger is further configured to supply the liquid back to the fuel cell stack.

16. The fuel cell system of claim 14, wherein the cathode heat exchanger is configured to condense at least a portion of the fluid into the liquid and wherein the anode heat exchanger is further configured to store the condensed liquid.

17. The fuel cell system of claim 14, wherein the fluid includes first and second fluids respectively generated by anode and cathode reactions, the fuel cell system further comprising:
a first inflow pipe configured to receive the first fluid from the fuel cell stack; and
a second inflow pipe configured to receive the second fluid from the fuel cell stack,
wherein the inlet header is connected to the fuel cell stack via the first and second inflow pipes.

18. The fuel cell system of claim 14, wherein the heat exchanger further comprises a liquid level measuring unit configured to measure the amount of liquid stored in the anode heat exchanger and wherein the liquid level measuring unit is formed on an outer surface of the anode heat exchanger.

19. The fuel cell system of claim 18, wherein the liquid level measuring portion is configured to control the discharge of the liquid through a liquid discharge port when the amount of liquid stored in the anode heat exchanger is greater than a threshold.

20. The fuel cell system of claim 14, wherein each of the cathode and anode heat exchangers includes i) two header pipes, ii) a plurality of tubes arranged substantially perpendicular to and between the header pipes and configured to provide fluid communication between the header pipes, and iii) a plurality of wrinkled heat dissipation fins respectively interposed between the tubes.
